(19) United States
(12) Patent Application Publication
(10) Pub. No.: US 2005/0279684 A1
(43) Pub. Date: Dec. 22, 2005

(54) Water flow rate self-tuning device for pressurized gas-water mixer

(76) Inventor: Maxwell Hsu, Chung-Li (TW)

Correspondence Address: Yi-Wen Tseng, 4331 Stevens Battle Lane, Fairfax, VA, 22033, US

(21) Appl. No.: 10/871,384

(22) Filed: Jun. 21, 2004

(51) Int. Cl. C02F 1/78

(52) U.S. Cl. 210/192; 210/259; 210/266

(57) ABSTRACT

A water flow rate self-tuning device for a pressurized gas-water mixer, utilized in a multifunctional oxygenated water machine, is disclosed. The water flow rate self-tuning device of the present invention can automatically regulate the size of its water output holes in response to the different water pressure of the incoming clean water, and therefore, maintain a stable water flow rate to insure that the pressurized gas-water mixer receives a steady water supply, and that the multifunctional oxygenated water machine provides consumers the potable ozonated water.

### BACKGROUND OF THE INVENTION

The present invention relates in general to a water flow rate self-tuning device for pressurized gas-water mixer, and more particularly, to a water flow rate self-tuning device for pressurized gas-water mixer which is utilized in a multifunctional oxygenated water machine in order to provide the gas-water mixer a steady water supply.

Most drinking water machine utilize several pre-filters to remove the solid sediments from the water, then use a reverse osmosis filter to further remove other impurities, and finally use a post-filter to remove any strange odor from the water. Water that has gone through this process becomes safe and potable and is referred to as pure water. However, there is a problem that arises from this kind of filtering. This problem arises because the filtering process skims out both dirty particles and organic materials. The skimmed out organic material gradually accumulates with usage and facilitates the growth of unwanted bacteria in the filters. In order to avoid the health effects of the unwanted bacteria the consumer is forced to change the filters frequently. If the consumer does not change the filters frequently the bacteria density in the water produced will exceed the standard allowed for potable water.

Furthermore, even though the container is a closed space it is still highly probable that the container will become a virtual nirvana for bacteria. The water delivery outlet closest to the container is the most vulnerable to contamination by bacteria, but this is by no means the only site of potential contamination. This is because once the water delivery outlet closest to the container is contaminated, the bacteria will likely migrate to the rear of the container. There is, therefore, a need to kill the bacteria in the container.

In order to kill the bacteria in the container an ozone generator is installed in an ozonated water producer. The Ozone produced from this ozone generator will dissolve into the water producing ozonated water. This ozonated water will then effectively suppress the growth of the unwanted bacteria. However, the conventional ozonated water producer requires a longer period of time in order for it to dissolve the ozone into its pure water. Because of the longer period of time required by the conventional ozonated water producer, it could not produce ozonated water quickly enough for the consumer; the time required by the conventional ozonated water producer made its use inconvenient to consumers.

### BRIEF SUMMARY OF THE INVENTION

The present invention provides a water flow rate self-tuning device for a pressurized gas-water mixer which is utilized in a multifunctional oxygenated water machine. The water flow rate self-tuning device of the present invention can automatically regulate the size of its water output holes in response to the different water pressure of the incoming clean water, and therefore, maintain a stable water flow rate to insure that the pressurized gas-water mixer receives a steady water supply, and that the multifunctional oxygenated water machine provides consumers the potable ozonated water.

The pressurized gas-water mixer provided by the present invention includes a hollow mixer main body formed by screwing a lower cylindrical container to the upper cylindrical container, a clear water inlet, an ozone gas inlet, a water flow rate self-tuning device, a water outlet, and a water level detecting device. The pressurized gas-water mixer receives clean water at its water inlet, and receives ozone gas at its ozone gas inlet. The clean water entering the pressurized gas-water mixer will pass through the water flow rate self-tuning device and then spray against an inner wall of the upper cylindrical container. When the clean water is sprayed out from the water flow rate self-tuning device, a foggy eddy will be produced. The many currents flowing from the different water output holes of the water flow rate self-tuning device will collide with each other, neutralizing and mixing with ozone gas. This mixing will generate high concentration electrolised ozonated water or the super oxygenated electrolised ozonated water, which will be stored in the lower cylindrical container for immediate use by the consumer. The water level detecting device is installed to maintain a suitable amount of ozonated water stored in the lower cylinder container. When the water level of the ozonated water stored exceeds the high water level, the high water level sensor will send a signal out to request the multifunctional oxygenated water machine to stop generating ozonated water. When the water level of the ozonated water stored drops below the low water level, the low water level sensor will send a signal out to request the multifunctional oxygenated water machine to generate more ozonated water.

The water flow rate self-tuning device provided by the present invention includes a fixed mount which has openings cut from its sides, an outer cylinder installed inside the fixed mount, an inner cylinder installed into the outer cylinder, and a compression spring pressed into the space between the inner surface of the fixed mount and the bottom external surface of the inner cylinder. Water flow rate regulating holes are bored from the side surface of the outer cylinder and from the side surface of the inner cylinder. These water flow rate regulating holes form water output holes. When the force the water pressure exerting on the inner cylinder is greater than the spring force of the compression spring, the inner cylinder will go down. The water output holes formed by the water flow regulating holes will decrease in size. The water flow rate enlarged by the greater water pressure will be reduced by the smaller water output holes. On the contrary, when the input water pressure becomes smaller, the force the water pressure exerting on the inner cylinder is smaller than the spring force of the compression spring. The inner cylinder will be forced upward by the compression spring. The water output holes will increase in size. The water flow rate reduced by the smaller input water pressure will be enhanced by the bigger water output holes. Thereby, the water flow rate self-tuning device of the present invention can automatically regulate the size of its water output holes in response to the different water pressure of the incoming clean water, and therefore, maintain a steady water flow rate to insure that the pressurized gas-water mixer receives a steady water supply. By utilizing the water flow rate self-tuning device for a pressurized gas-water mixer, the multifunctional oxygenated water machine can provide consumers the potable ozonated water.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 is a system diagram of a multifunctional oxygenated water machine.

FIG. 2 is a cross-sectional view of a pressurized gas-water mixer in accordance with the present invention.

FIG. 3 is an enlarged cross-sectional view of a water flow rate self-tuning device for a pressurized gas-water mixer in accordance with the present invention.

FIG. 4 is a partial cross-sectional view of a pressurized gas-water mixer illustrating the operation of a water flow self-tuning device for the pressurized gas-water mixer.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

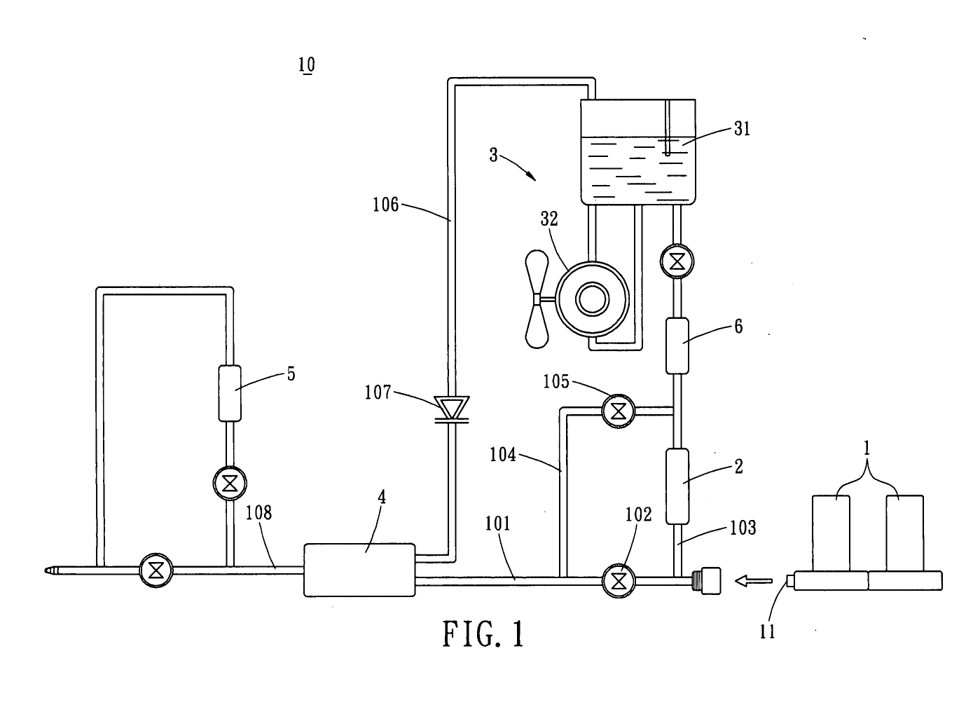

Referring to FIG. 1, a system diagram of a multifunctional oxygenated water machine 10 is shown. The multifunctional oxygenated water machine includes a pre-filter 1, a clean water generator 2, an ozone gas generator 3, a pressurized gas-water mixer 4, a restorer 5, and a pure water generator 6. Before directing to the multifunctional oxygenated water machine, the source water flows into the pre-filter 1. The pre-filter 1 contains a 5 μmm filter cartridge and a ceramic filter cartridge, which can effectively filter out impurities, planktons, chlorides, and most bacteria and viruses. The water outlet 11 of the pre-filter 1 connects to the water inlet 42 of the pressurized gas-water mixer 4 via a first water conveying pipeline 101. A solenoid valve 102 installed in the first water conveying pipeline 101 controls the conveying of the preliminary clean water. A second water-conveying pipeline 103 connects to the first water conveying pipeline 101 at a location before the solenoid valve 102. The clean water generator 2, installed in the second water-conveying pipeline 103, contains a filter cartridge with copper ions, zinc ions, and activated carbons; it can effectively filter out various heavy metal elements, inorganic materials and chlorides. A third water-conveying pipeline 104 conveys the clean water generated by the clean water generator 2 to the pressurized gas-water mixer 4. The inlet of the third water-conveying pipeline 104 connects to the second water-conveying pipeline 103 at a location between the clean water generator 2 and the pure water generator 6. The outlet of the third water-conveying pipeline 104 connects to the first water conveying pipeline 101 at a location between the solenoid valve 102 and the pressurized gas-water mixer 4. A solenoid valve 105 is installed in the third water-conveying pipeline 104 to control the conveying of clean water. Thereby, by controlling the solenoid valve 102 and the solenoid valve 105, the water provided to the pressurized gas-water mixer 4 can be either the preliminary clean water coming directly from the pre-filter 1 or the clean water passing through both the pre-filter 1 and the clean water generator 2.

The clean water generated by the clean water generator 2 can also be directed to the pure water generator 6. The pure water generator 6, its inlet connecting to the water-conveying pipeline 103, its outlet connecting to a pure water tank 31 of the ozone gas generator 3 through a pipeline with a control valve, contains a filter cartridge with ion exchange resins. It transforms clear water generated by the clean water generator 2 into pure water that the ozone gas generator 3 needs. The ozone gas generator 3 includes the pure water tank 31 and an ozone generator 32 which reacts with pure water and produces a mixture of ozone, oxygen, and water. The mixture of ozone, oxygen, and water is directed back to the pure water tank 31 via a pipeline. The pure water tank outputs ozone gas to the pressurized gas-water mixer 4 via a gas pipeline 106 in which a check valve 107 is installed.

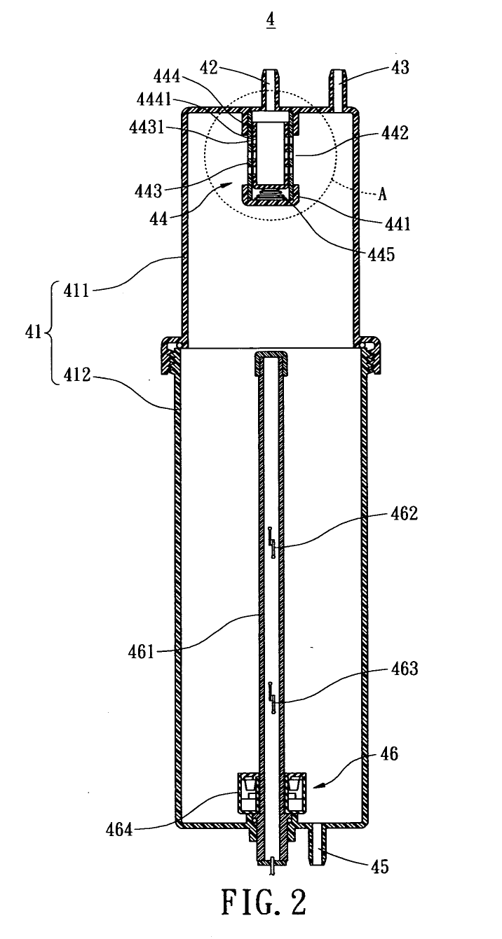

Referring to the FIG. 2, a cross sectional view of a pressurized gas-water mixer in accordance with the present invention is shown. The pressurized gas-water mixer 4 includes a hollow mixer main body 41 formed by screwing a lower cylindrical container 412 to the upper cylindrical container 411, a clear water inlet 42, an ozone gas inlet 43, a water flow rate self-tuning device 44, a water outlet 45, and a water level detecting device 46. The clear water inlet 42, connecting to the first water conveying pipeline 101, provides either the preliminary clean water coming directly from the pre-filter 1 or the clean water passing through both the pre-filter 1 and the clean water generator 2 to the mixer main body 41.

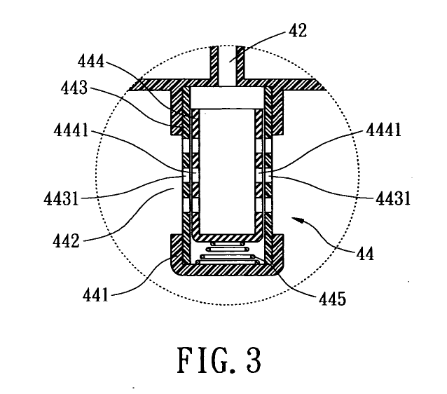

Referring to the FIG. 3, an enlarged cross-sectional view of a water flow rate self-tuning device for a pressurized gas-water mixer in accordance with the present invention is shown. The water flow rate self-tuning device 44, by utilizing the pressure of the incoming water, regulates automatically the size of its water output holes to provide the gas-water mixer 4 a steady water supply. The water flow rate self-tuning device 44, installed at the top inner surface of the upper cylindrical container 411, includes a fixed mount 441 which has openings 442 cut from its sides, an outer cylinder 443 installed inside the fixed mount 441, an inner cylinder 444 installed into the outer cylinder 443, and a compression spring 445 pressed into the space between the inner surface of the fixed mount 441 and the bottom external surface of the inner cylinder 444. Water flow rate regulating holes 4431 are bored from the side surface of the outer cylinder 443. Water flow regulating holes 4441 are bored from the side surface of the inner cylinder 444. These water flow rate regulating holes form the water output holes of the water rate self-tuning device 44 and allow incoming clean water spraying against the inner wall of the upper cylindrical container 411.

The water level detecting device 46 is provided to maintain a suitable amount of ozonated water stored in the lower cylinder container 412 for immediate use by the consumer. The water level detecting device 46, located inside the lower cylindrical container 412, includes a hollow cylinder 461, a high water level sensor 462 and a low water level sensor 463 both fixed inside the hollow cylinder 461, and a floating device 464 sleeved around the hollow cylinder 461 in which a magnet is incorporated to provide electromagnetic induction. When the floating device 464 floats up above the high water level, the high water level sensor 462 senses the magnetism and then sends a signal out to request the super oxygenated electrolised ozonated water generator 10 to stop generating water. When the floating device 464 drops down below the low water level, the low water level sensor 463 senses the magnetism and then sends a signal out to request the multifunctional oxygenated water machine 10 to generate more ozonated water. Thereby, the pressurized gas-water mixer 4 maintains an adequate water level and can consistently provide the high concentration electrolised ozonated water or the super oxygenated electrolised ozonated water.

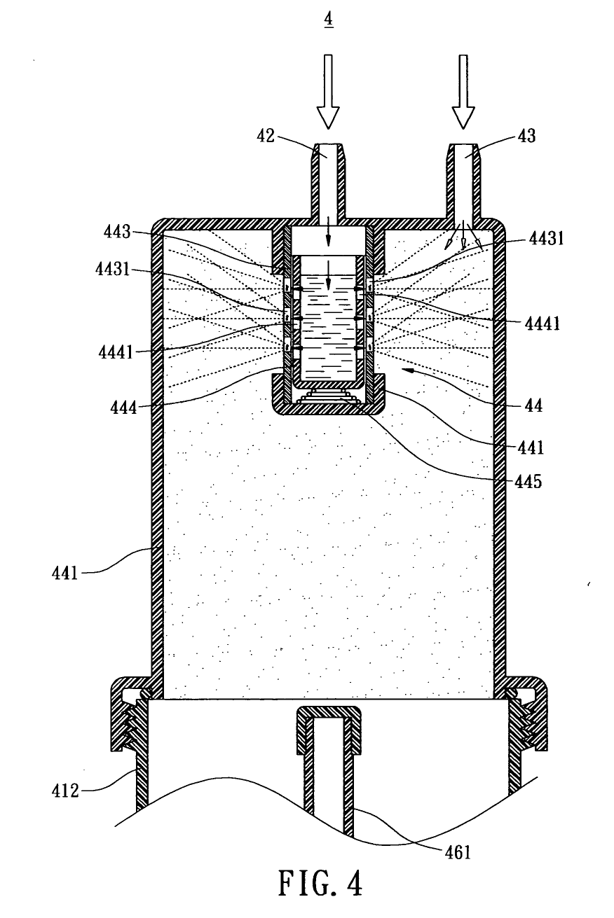

Referring to FIG. 4, a partial cross-sectional view of a pressurized gas-water mixer illustrating the operation of the water flow self-tuning device is shown. The clean water transported to the pressurized gas-water mixer 4 first enters the inner cylinder 444 of the water flow rate self-tuning device 44, further passes through the water output holes formed by the water flow regulating holes 4441 of the inner cylinder 444 and the water flow regulating holes 4431 of the outer cylinder 443, and then sprays in a foggy style against the inner wall of the upper cylindrical container 411. When the clean water is sprayed out from the water output holes, a foggy eddy will be produced. The many currents flowing from the different water output holes will collide with each other, neutralizing and mixing with ozone gas. This mixing will further generate high concentration electrolised ozonated water or the super oxygenated electrolised ozonated water, which will be stored in the lower cylindrical container 412 for immediate use by the consumer.

Furthermore, the inner cylinder 444 will change its vertical position in response to the different water pressure at the water inlet 42. When the force the water pressure exerting on the bottom of the inner cylinder 444 is greater than the spring force of the compression spring 445, the inner cylinder 444 will go down. The water flow regulating holes 4441 of the inner cylinder 444 will not coincide with the water flow regulating holes 4431 of the outer cylinder 443. The water output holes formed by the water flow regulating holes 4441 and the water flow regulating holes 4431 will decrease in size. The water flow rate enlarged by the greater water pressure will be reduced by the smaller water output holes of the water flow rate self-tuning device 44. On the contrary, when the input water pressure becomes smaller, the force the water pressure exerting on the bottom of the inner cylinder 444 is smaller than the spring force of the compression spring 445. The inner cylinder 444 will be forced upward because of the release of the potential force stored in the compression spring 445. The water output holes formed by the water flow regulating holes 4441 and the water flow regulating holes 4431 will increase in size. The water flow rate reduced by the smaller input water pressure will be enhanced by the larger water output holes of the water flow rate self-tuning device 44.

Thereby, the water flow rate self-tuning device of the present invention can automatically regulate the size of its water output holes in response to the different water pressure of the incoming clean water, and therefore, maintain a steady water flow rate to insure that the pressurized gas-water mixer receives a steady water supply. By utilizing the water flow rate self-tuning device for a pressurized gas-water mixer, a multifunctional oxygenated water machine can provide consumers potable ozonated water.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

1. A water flow rate self-tuning device for pressurized gas-water mixer installed in a multifunctional oxygenated water machine, wherein the pressurized gas-water mixer having a hollow mixer main body, a clear water inlet connected to a water-conveying pipeline, an ozone gas inlet connected to a gas-conveying pipeline, and a water outlet, the water flow rate self-tuning device comprising:
a fixed mount having openings cut from a side surface thereof;
an outer cylinder installed inside the fixed mount, having water flow regulating holes formed on a side surface thereof;
an inner cylinder installed into the outer cylinder, having water flow regulating holes formed on a side surface thereof; and
a compression spring pressed into the space between the inner bottom surface of the fixed mount and the bottom external surface of the inner cylinder.

2. The water flow rate self-tuning device for pressurized gas-water mixer of claim 1, further comprising a water level detecting device to maintain a suitable amount of ozonated water stored in the lower cylinder container, wherein the water level detecting device located inside the lower cylindrical container includes a hollow cylinder, a high water level sensor and a low water level sensor both fixed inside the hollow cylinder, and a floating device sleeved around the hollow cylinder in which a magnet is incorporated to provide electromagnetic induction.

3. A multifunctional oxygenated water machine, comprising a pre-filter, a clean water generator; an ozone gas generator; a pressurized gas-water mixer; a restorer and a pure water generator,
wherein the pressurized gas-water mixer further including a hollow mixer main body, a clear water inlet connected to a water-conveying pipeline, an ozone gas inlet connected to a gas-conveying pipeline, and a water outlet, and a water flow rate self-tuning device including a fixed mount having openings cut from a side surface thereof, an outer cylinder installed inside the fixed mount having water flow regulating holes formed on a side surface thereof, an inner cylinder installed into the outer cylinder having water flow regulating holes formed on a side surface thereof, and a compression spring pressed into the space between the inner bottom surface of the fixed mount and the bottom external surface of the inner cylinder.

4. The multifunctional oxygenated water machine of claim 3, wherein the pre-filter connects to the pressurized gas-water mixer via a first water-conveying pipeline in which a solenoid valve is installed for controlling the conveying of the water, the first water-conveying pipeline is connected by a second water-conveying pipeline at a location before the solenoid valve, the second water-conveying pipeline in which a clean water generator is installed for producing clean water is connected by a third water-conveying pipeline which transports clean water generated by the clean water generator to the first water-conveying pipeline.

5. The multifunctional oxygenated water machine of claim 4, wherein the pre-filter has a 5 μmm filter cartridge and a ceramic filter cartridge.

6. The multifunctional oxygenated water machine of claim 4, wherein the clean water generator has a filter cartridge containing copper ions, zinc ions, and activated carbons.

7. The multifunctional oxygenated water machine of claim 4, wherein the pure water generator has a filter cartridge containing ion exchange resins.

8. The multifunctional oxygenated water machine of claim 3, wherein the ozone gas generator has a pure water tank and an ozone generator which reacts with pure water and produces a mixture of ozone, oxygen, and water, and wherein the mixture of ozone, oxygen, and water is directed back to the pure water tank which outputs the ozone gas to the pressurized gas-water mixer via a pipeline in which a check valve is installed.

9. The multifunctional oxygenated water machine of claim 8, wherein the pre-filter directly transport water to the pressurized gas-water mixer for mixing with the ozone gas to form high concentration electrolised ozonated water.

10. The water flow rate self-tuning device for pressurized gas-water mixer of claim 8, wherein the pre-filter transport water to the clean water generator and then to the pressurized gas-water mixer via the third water-conveying pipeline and the first water-conveying pipeline for mixing with the ozone gas to form super oxygenated electrolised ozonated water.

11. The multifunctional oxygenated water machine of claim 3, wherein the hollow mixer main body is formed by screwing a lower cylindrical container having a water outlet to the upper cylindrical container having a water inlet and a gas inlet.

12. The multifunctional oxygenated water machine of claim 3, wherein the water flow rate self-tuning device further comprising a water level detecting device to maintain a suitable amount of ozonated water stored in the lower cylinder container, wherein the water level detecting device located inside the lower cylindrical container includes a hollow cylinder, a high water level sensor and a low water level sensor both fixed inside the hollow cylinder, and a floating device sleeved around the hollow cylinder in which a magnet is incorporated to provide electromagnetic induction.
